(19) United States
(12) Patent Application Publication
(10) Pub. No.: US 2026/0362277 A1
(43) Pub. Date: Nov. 12, 2026

(54) ADJUSTMENT DEVICE FOR ADJUSTING ANTENNA OF BASE STATION IN A FIELD AND FIELD RADIO FREQUENCY SIGNAL OPTIMIZATION METHOD

(71) Applicant: LITE-ON TECHNOLOGY CORPORATION, Taipei (TW)

(72) Inventor: Jin-Jye CHOU, Taipei (TW)

(21) Appl. No.: 19/671,284

(22) Filed: May 8, 2026

Related U.S. Application Data
(60) Provisional application No. 63/802,739, filed on May 9, 2025.

(30) Foreign Application Priority Data
Mar. 13, 2026 (CN) 202610305094.6

(51) Int. Cl. H04W 36/30; H04B 17/318; H04B 17/336

(52) U.S. Cl. CPC H04W 36/302; H04B 17/328; H04B 17/336; H04W 36/304

(57) ABSTRACT

An adjustment device, used to adjust at least one antenna of a base station deployed in a field, includes an antenna adjustment unit used to adjust multiple angles of the at least one antenna. Furthermore, a control unit is used to control the antenna adjustment unit to adjust the angles of the at least one antenna, so as to cause a terminal device reaches a first and a second minimum signal strengths at a coverage distance and a registration handover distance of the base station respectively. When the terminal device reaches lower limits of predefined uplink and downlink rates at the coverage distance, the terminal device selectively initiates registration handover at the registration handover distance. A deployment reference distance between the base station and an adjacent base station is greater than or equal to the coverage distance and the registration handover distance.

This application claims the benefit of U.S. provisional application Ser. No. 63/802,739, filed May 9, 2025, and CN application No. 202610305094.6, filed Mar. 13, 2026, the disclosure of which is incorporated by reference herein in its entirety.

### TECHNICAL FIELD

The present disclosure relates to a planning for a field radio frequency (RF) signal, and particularly relates to an adjustment device for antennas of a base station and an optimization method for the field RF signal.

### BACKGROUND

Wireless transmission equipment (such as 5G small base stations or wireless access points (AP)) is typically mounted at high points in a field (e.g., ceilings, walls, or light poles) to provide communication services to terminal devices. Depending on the actual application environment of the field, the settings of the wireless transmission equipment must be adjusted (e.g., adjusting the antenna angle) to satisfy the application requirements of the filed. When deploying the wireless transmission equipment in the field, actual area of the field and product test data from the supplier of the wireless transmission equipment have to be taken into consideration for determining the number of devices and the predefined deployment locations.

The heights of different predefined deployment locations, the angle of the antenna, and obstacles in the field can affect the quality of the RF signal of the wireless transmission equipment. Therefore, the deployed wireless transmission equipment must be adjusted. However, the adjustment of wireless transmission equipment usually requires professional maintenance personnel to manually adjust the antennas, which consumes manpower and time costs, and hence reduces the quality of the network commercial service provided by the wireless transmission equipment.

On the other hand, multiple wireless transmission devices in the field can allow terminal devices to perform registration handover, and the terminal devices may evaluate the quality of the currently received RF signal, so as to decide whether to initiate the registration handover. However, when deploying wireless transmission equipment in the field, the schemes of registration handover are not considered beforehand. Furthermore, in actual operation, the terminal devices may not be able to properly initiate registration handover. Therefore, professional maintenance personnel is required to manually adjust the antenna, so as to satisfy application requirements for the registration handover of the terminal devices.

In view of the above issues, it is desirable to have an improved optimization method for the field RF signals and an adjustment device for implementing the above method.

### SUMMARY

According to an embodiment of the present disclosure, an adjustment device is provided for adjusting at least one antenna of a base station, wherein the base station is disposed in a field. The adjustment device includes the following components. An antenna adjustment unit having a subordinate role in a Bluetooth protocol and for adjusting a plurality of angles of the at least one antenna. A control unit having a master role in a Bluetooth protocol and controlling the antenna adjustment unit to adjust the angles of the at least one antenna via a Bluetooth communication interface, so that the RF signal of the base station received by a terminal device at a coverage distance and a registration handover distance of the base station respectively reaches a first minimum signal strength and a second minimum signal strength. When the coverage distance reaches a predefined lower limit of uplink rate and a predefined lower limit of downlink rate, the terminal device selectively initiates registration handover of the base station at the registration handover distance, wherein a deployment reference distance between the base station and an adjacent base station is greater than or equal to the coverage distance, and the coverage distance is greater than or equal to the registration handover distance.

According to another embodiment of the present disclosure, a field RF signal optimization method is provided for adjusting at least one antenna of a base station deployed in a field. The field RF signal optimization method includes the following steps. Mounting the base station at a predefined deployment location in the field. Controlling an antenna adjustment unit having a master role with a Bluetooth protocol via a Bluetooth communication interface to control an antenna adjustment unit having a slave role with the Bluetooth protocol. Adjusting a plurality of angles of the at least one antenna by the antenna adjustment unit. Causing a terminal device to receive the RF signal of the base station at a coverage distance of the base station to reach a first minimum signal strength, wherein when the coverage distance reaches a predefined lower limit of uplink rate and a predefined lower limit of downlink rate, the terminal device receives the RF signal of the base station at a registration handover distance of the base station to reach a second minimum signal strength, and the terminal device selectively initiates registration handover of the base station at the registration handover distance. A deployment reference distance between the base station and an adjacent base station is greater than or equal to the coverage distance, and the coverage distance is greater than or equal to the registration handover distance.

### BRIEF DESCRIPTION OF THE DRAWINGS

FIG. 1 is a schematic diagram showing the base stations C1-C8 deployed in the field 1000 according to an embodiment of the present disclosure.

FIG. 2 is a schematic diagram showing the coverage distances R11-R81 and registration handover distances R12-R82 of the base stations C1-C8 in FIG. 1.

FIG. 3 is a flow diagram of an optimization method for a field RF signal according to an embodiment of the present disclosure.

FIGS. 4A and 4B are schematic diagrams showing the measuring of signal strength at the coverage distance Ri1 and the registration handover distance Ri2 of the base station Ci.

FIGS. 5A and 5B are schematic diagrams of showing the adjusting of the angle of the antenna of the base station Ci for the signal strength at the coverage distance Ri1 of the base station Ci.

FIG. 5C is a schematic diagram showing the adjusting of the angle of the antenna of the base station Ci for the signal strength at the registration handover distance Ri2 of the base station Ci.

FIG. 6 is a schematic diagram showing the minimum signal strength Min_RSRPi-j2 of the terminal device at the registration handover distance Rj2 of the base station Cj.

FIG. 7A is a block diagram of the adjustment device 200 according to an embodiment of the present disclosure.

FIG. 7B is a block diagram of the charging base 24.

FIG. 7C is a block diagram of the adjustment device 200b according to another embodiment of the present disclosure.

FIG. 8 is a schematic diagram showing the adjustment for multiple antennas of the base station C1.

FIG. 9 is a block diagram of the control unit 21.

FIG. 10 is a schematic diagram showing the control unit 21 performs Bluetooth pairing.

FIG. 11 is a block diagram of the base station message send/receive unit 22.

FIG. 12 is a block diagram of the antenna adjustment unit 23.

FIG. 13 is a schematic diagram showing the operation of the antenna adjustment unit 23.

FIG. 14 is a schematic diagram showing the axes of the XY plane PL1 and the Z plane PL2 of the base station C1, and the rotation directions of the motors M1 and M2 of the antenna adjustment unit 23.

FIG. 15 is a schematic diagram showing the adjusting for the antenna array A1 of the base station C1.

FIG. 16 is a flow diagram of an optimization method for a field RF signal according to another embodiment of the present disclosure.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

### DETAILED DESCRIPTION

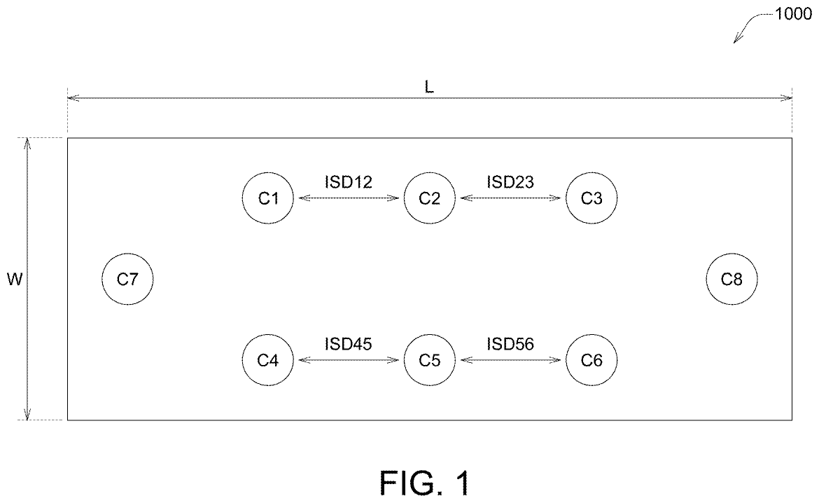

FIG. 1 is a schematic diagram showing the base stations C1-C8 deployed in the field 1000 according to an embodiment of the present disclosure. The field 1000 is a deployment scheme defined by the 3GPP standard, such as the “indoor open office” deployment scheme defined by 3GPP TR138.901. The method for optimizing field RF signals in the present disclosure involves the planning for the deployment of multiple wireless communication devices in the field 1000, and the adjusting the signal quality during the actual deployment phase of the wireless communication devices; the wireless communication devices include, for example, base stations C1-C8. Each of base stations C1-C8 is, for example, a 5G NR small base station. The dimensions of the field 1000 are the length L and the width W, and the RF signals of base stations C1-C8 can collectively cover the range defined by the length L and the width W.

The distance between any adjacent two of the base stations C1-C8 (i.e., the spacing between the adjacent two base stations) is defined as the deployment reference distance for base stations C1-C8. Specifically, the distance between the adjacent base stations Ci and Cj is defined as the deployment reference distance ISDij. In the embodiment of FIG. 1, there is a deployment reference distance ISD12 between adjacent base stations C1 and C2, a deployment reference distance ISD23 between adjacent base stations C2 and C3, a deployment reference distance ISD45 between adjacent base stations C4 and C5, and a deployment reference distance ISD56 between adjacent base stations C5 and C6.

In the method for optimizing field RF signals, the deployment reference distance ISDij of base stations C1-C8 is determined based on the performance of base stations C1-C8. The performance of base stations C1-C8 includes: (1) the transmission rate of wireless transmission between base stations C1-C8 and the terminal device (the terminal device is not shown in FIG. 1), and (2) the signal strength of the RF signal provided by base stations C1-C8. The transmission rate includes uplink and downlink rates, and the signal strength indicators of the RF signal include: Reference Signal Received Power (RSRP) and Signal-to-Interference-plus-Noise Ratio (SINR), and the like. The RSRP is, for example, the Channel State Information Reference Signal Received Power (CSI-RSRP).

The method for optimizing field RF signals should satisfy the following application requirements of the field 1000: (1) Taking the locations of base stations C1-C8 as reference points, beyond the predefined distances from the reference points, the transmission rate of wireless transmission between base stations C1-C8 and the terminal device must reach a predefined uplink rate and/or a predefined downlink rate; and (2) at the predefined distances from the reference points, the signal strength of the RF signal provided by base stations C1-C8 must reach a predefined signal strength. In one example, the predefined distances from the locations of base stations C1-C8 are, for example, 200 meters. Beyond 200 meters, each of base stations C1-C8 must support a predefined downlink rate of 100 Mbps, and the provided RF signal must reach a predefined signal strength of −117 dBm for the RSRP.

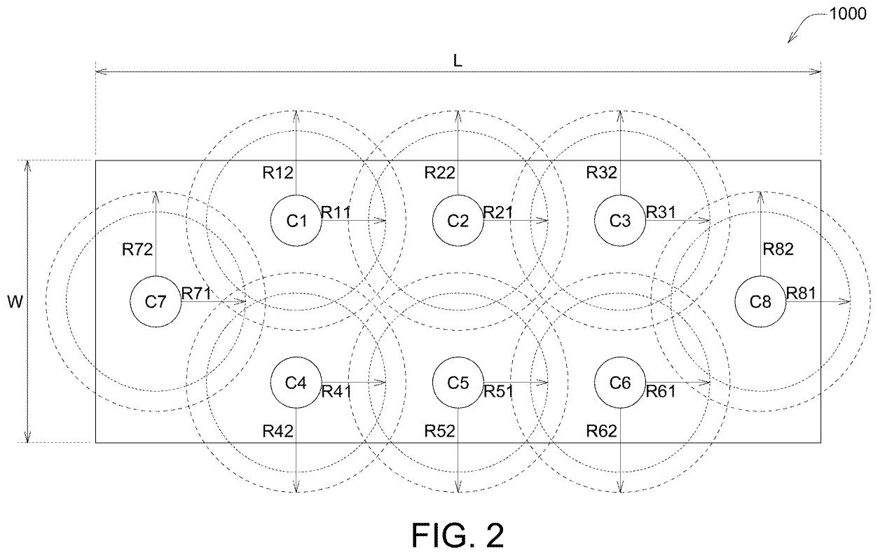

FIG. 2 is a schematic diagram showing the coverage distances R11-R81 and registration handover distances R12-R82 of the base stations C1-C8 in FIG. 1. Among the base stations C1-C8, the i-th base station Ci has a coverage distance Ri1 and a registration handover distance Ri2. The coverage distance Ri1 represents the distance at which the transmission rate of wireless transmission between base station Ci and the terminal device reaches an “edge rate”. The edge rate is a lower limit of the predefined uplink rate and/or the predefined downlink rate. The registration handover distance Ri2 represents the distance at which the terminal device selectively initiates registration handover of base station Ci. At coverage distance Ri1, the RF signal provided by base station Ci has a signal strength RSRPi1; its minimum signal strength Min_RSRPi1 satisfies the required edge rate. Furthermore, at registration handover distance Ri2, the RF signal provided by base station Ci has a signal strength RSRPi2; its minimum signal strength Min_RSRPi2 satisfies the requirement that the system will not reach the threshold for initiating registration handover within the registration handover distance Ri2. For example, base station C1 must achieve the minimum signal strength Min_RSRP11 at coverage distance R11 and the minimum signal strength Min_RSRP12 at registration handover distance R12; and base station C2 must achieve the minimum signal strength Min_RSRP21 at coverage distance R21 and the minimum signal strength Min_RSRP22 at registration handover distance R22, and so on.

In the example of FIG. 2, each of base stations C1-C8, for example, has the same coverage distance and the same registration handover distance. That is, the coverage distance Ri1 of base station Ci among base stations C1-C8 is equal to the coverage distance Rk1 of any other base station Ck, and the registration handover distance Ri2 of base station Ci is equal to the registration handover distance Rk2 of base station Ck. Correspondingly, the minimum signal strength Min_RSRPi1 that base station Ci must achieve at coverage distance Ri1 and the minimum signal strength Min_RSRPi2 that base station Ci must achieve at registration handover distance Ri2 are respectively equal to the minimum signal strength Min_RSRPk1 that base station Ck must achieve at coverage distance Rk1 and the minimum signal strength Min_RSRPk2 that base station Ck must achieve at registration handover distance Rk2.

In other examples, the coverage distances Ri1 and Rk1 of any two base stations Ci and Ck may be unequal, and their respective registration handover distances Ri2 and Rk2 may also be unequal. Furthermore, the minimum signal strengths Min_RSRPi1 and Min_RSRPk1 of base stations Ci and Ck at coverage distances Ri1 and Rk1 respectively may be unequal, and the minimum signal strengths Min_RSRPi2 and Min_RSRPk2 of base stations Ci and Ck at registration handover distances Ri2 and Rk2 respectively can also be unequal.

More specifically, the application requirement of the field 1000 is: to support the minimum signal strength Min_RSRP11 required for the coverage distance R11 of base station C1. The coverage distance R11 is 30 meters, and the edge rate that must be achieved at 30 meters is 500 Mbps, with a corresponding signal strength (CSI-RSRP) of −85 dBm. Therefore, the minimum signal strength Min_RSRP11 of base station C1 at the coverage distance R11 is −85 dBm.

When the coverage distances Ri1 and Rk1 of any two base stations Ci and Ck are equal, the coverage distance Ri1 of base station Ci is equal to the coverage distance Rj1 of the adjacent base station Cj. In one example, the deployment reference distance ISDij between base stations Ci and Cj is used as the coverage distance Ri1. That is, the deployment reference distance ISDij between base stations Ci and Cj is equal to the coverage distance Ri1 and is greater than or equal to the registration handover distance Ri2, as shown in equation (1).

ISDij=Ri1(=Rj1)>=Ri2 (1)

In another example, the deployment reference distance ISDij between base stations Ci and Cj is greater than the coverage distance Ri1 and greater than or equal to the registration handover distance Ri2, as shown in equation (2).

ISDij>Ri1(=Rj1)>=Ri2 (2)

Because the deployment reference distance ISDij is greater than the coverage distance Ri1, a terminal device registered with base station Ci (terminal device not shown in FIG. 2) may be in a transition area before registration handover with base station Cj. The transmission rate between the terminal device and base station Ci may be less than the edge rate, or the signal strength received by the terminal device from base station Ci may be less than the minimum signal strength Min_RSRPi2. In this situation, if the signal strength received by the terminal device remains less than the minimum signal strength Min_RSRPi2, the core network decides whether to initiate a registration handover.

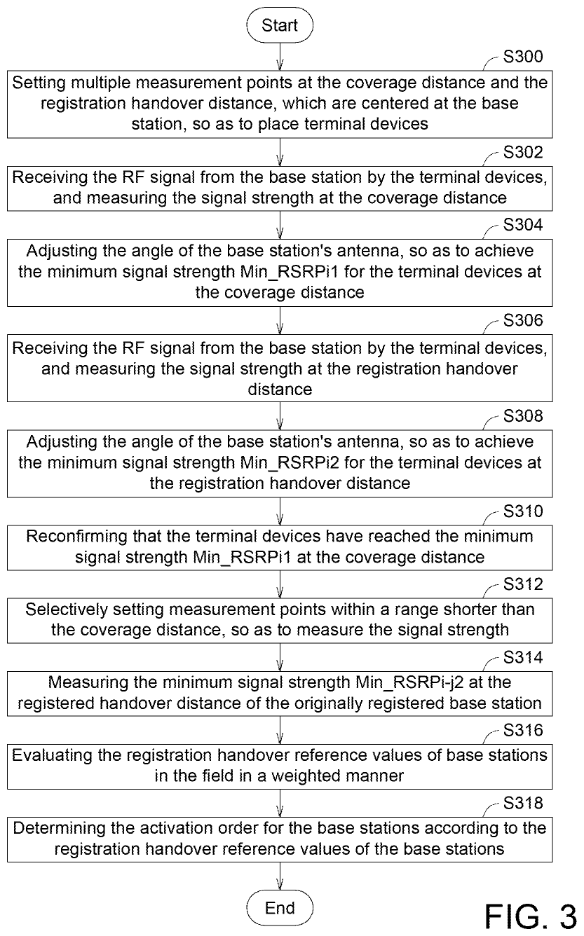

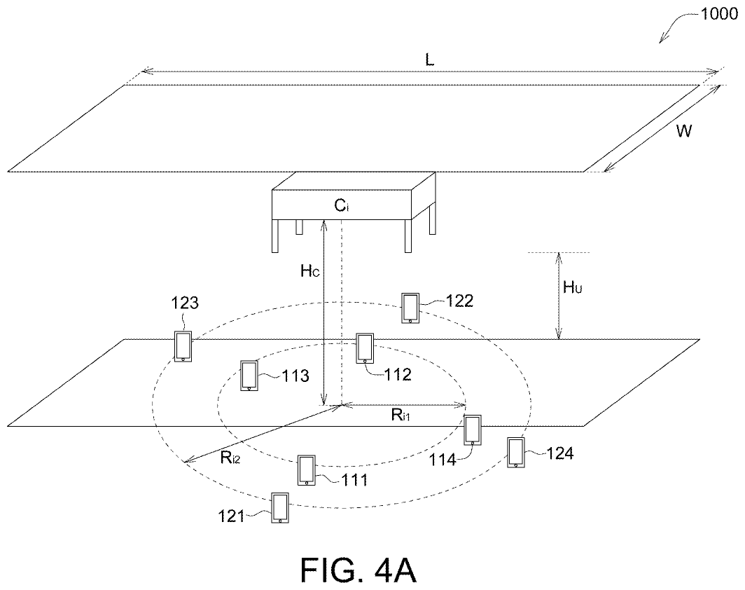

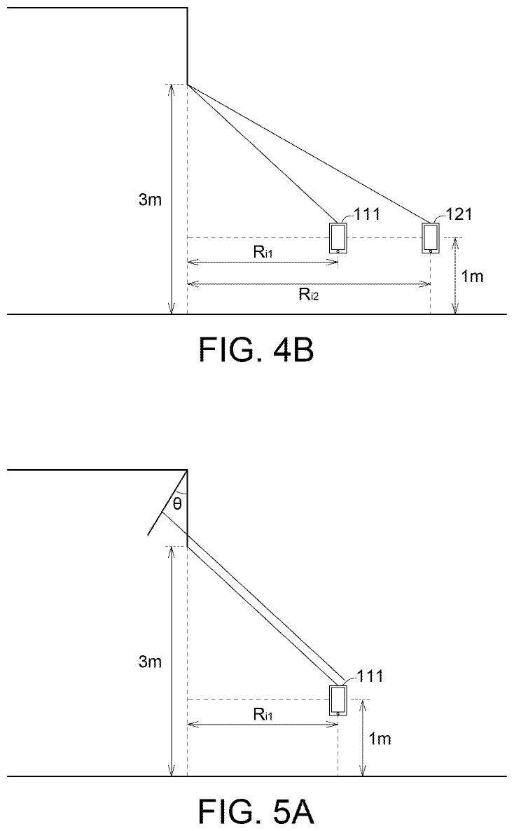

FIG. 3 is a flow diagram of an optimization method for a field RF signal according to an embodiment of the present disclosure. FIGS. 4A and 4B are schematic diagrams showing the measuring of signal strength at the coverage distance Ri1 and the registration handover distance Ri2 of the base station Ci. Please refer to FIGS. 3, 4A, and 4B, in step S300, multiple measurement points are set at the coverage distance Ri1 and registration handover distance Ri2 of base station Ci, centered on the location of base station Ci, and corresponding terminal devices are placed at the measurement points. For example, at coverage distance Ri1, measurement points are set in four directions (front, back, left and right) of base station Ci for placing terminal devices 111, 112, 113 and 114. Furthermore, at registration handover distance Ri2, measurement points are set in four directions (front, back, left and right) of base station Ci for placing terminal devices 121, 122, 123 and 124. The height of the placement position of the antenna of base station Ci is defined as “antenna height Hc”. The antenna of base station Ci may be, for example, an internal antenna or an external antenna. Furthermore, the height of the placement positions of terminal devices 111-114 and terminal devices 121-124 is defined as “device height Hu”. In the example of indoor open office in 3GPP, the antenna height Hc of base station Ci is, for example, 3 meters, and the device height Hu of terminal devices 111-114 and terminal devices 121-124 is, for example, 1 meter. FIG. 4B only shows terminal devices 111 and 121.

Then, in step S302, terminal devices 111, 112, 113 and 114 are used to receive the RF signal from base station Ci, and measure the signal strength at the coverage distance Ri1.

Then, in step S304, the angle of the antenna of base station Ci is adjusted so that the RF signal received by terminal devices 111, 112, 113 and 114 at the coverage distance Ri1 reaches the minimum signal strength Min_RSRPi1. The antenna of base station Ci is, for example, an omnidirectional antenna of different types, and its angle can be adjusted according to the radiation pattern of each type of antenna.

Then, in step S306, terminal devices 121, 122, 123 and 124 are used to receive the RF signal from base station Ci, and measure the signal strength at the registration handover distance Ri2.

Then, in step S308, the angle of the antenna of base station Ci is adjusted so that the RF signal received by terminal devices 121, 122, 123 and 124 at the registration handover distance Ri2 reaches the minimum signal strength Min_RSRPi2.

Then, in step S310, confirming again whether terminal devices 111, 112, 113 and 114 reach the minimum signal strength Min_RSRPi1 at the coverage distance Ri1. If the adjusted antenna angle cannot simultaneously satisfy the minimum signal strength Min_RSRPi1 of the coverage distance Ri1 and the minimum signal strength Min_RSRPi2 of the registration handover distance Ri2, then satisfying the minimum signal strength Min_RSRPi1 of the coverage distance Ri1 takes priority.

On the other hand, step S312 can be selectively executed: measurement points are set at multiple locations within a range shorter than the coverage distance Ri1, so as to measure and verify the signal strength.

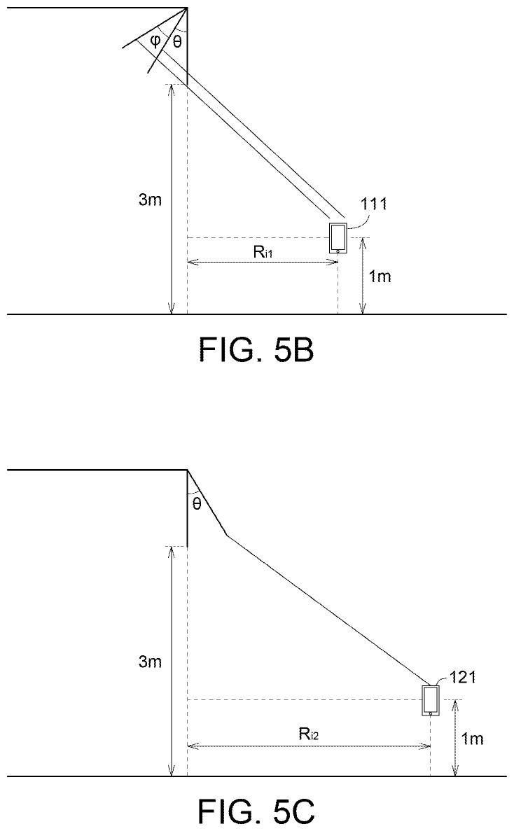

FIGS. 5A and 5B are schematic diagrams of showing the adjusting of the angle of the antenna of the base station Ci for the signal strength at the coverage distance Ri1 of the base station Ci. Also, FIGS. 5A and 5B further illustrate step S304 of FIG. 3, in which the antenna angle is adjusted to ensure the minimum signal strength Min_RSRPi1 is satisfied at the coverage distance Ri1. In FIGS. 5A and 5B, only the terminal device 111 is shown.

Firstly, referring to FIG. 5A, in an initial state, the antenna angle of base station Ci is adjusted to a vertical direction, and the signal strength RSRPi1 received by terminal device 111 at the coverage distance Ri1 is measured. If the measured signal strength RSRPi1 is greater than the minimum signal strength Min_RSRPi1, it indicates that the coverage distance Ri1 of base station Ci satisfies the application requirements of the field 1000, and therefore there is no need to adjust the antenna angle.

If the measured signal strength RSRPi1 is less than the minimum signal strength Min_RSRPi1, the antenna angle of base station Ci must be adjusted. In one example, the radiation pattern of antenna is that, energy radiation is concentrated along the x-axis or y-axis of a spatial sphere. Therefore, the first angle θ of the antenna can be adjusted so that the terminal device 111 can receive a higher signal strength at a coverage distance Ri1. Specifically, the adjusting range of the first angle θ of the antenna may depend on the antenna height Hc of base station Ci, the device height Hu of terminal device 111, the coverage distance Ri1, and the energy distribution of the radiation pattern of the antenna. For example, an initial reference angle is set according to the half-power beam-width (HPBW), and the first angle θ is adjusted accordingly. If the angle adjustment according to the HPBW still cannot satisfy the minimum signal strength Min_RSRPi1, the first angle θ is increased to achieve consistency between the direction of the main beam of antenna and the direction of the terminal device 111. If the antenna height Hc and device height Hu are limited, then, 1 degree can be used as the adjusting step unit for the first angle θ.

In another example, the radiation pattern of the antenna is such that the energy radiation is not concentrated along the x-axis or y-axis of the spatial sphere, but rather offset towards the z-axis, then, as shown in the example of FIG. 5B, the second angle φ of the antenna can be adjusted so that the terminal device 111 can receive a higher signal strength at the coverage distance Ri1.

FIG. 5C is a schematic diagram showing the adjusting of the angle of the antenna of the base station Ci for the signal strength at the registration handover distance Ri2 of the base station Ci. Also, FIG. 5C further illustrates step S308 of FIG. 3, in which the antenna angle is adjusted so that the minimum signal strength Min_RSRPi2 is satisfied at the registration handover distance Ri2. In one example, when the radiation pattern of the antenna is such that the energy radiation is concentrated along the x-axis or y-axis of the spatial sphere, the adjustment method for the antenna angle in FIG. 5C is similar to that in FIG. 5A. If the signal strength RSRPi2 measured at the registration handover distance Ri2 is less than the minimum signal strength Min_RSRPi2, the first angle θ of the antenna is adjusted so that the terminal device 121 can receive a higher signal strength at the registration handover distance Ri2. In another example, if the radiation pattern of the antenna is such that energy radiation is offset towards the z-axis, then the second angle φ of the antenna (not shown in FIG. 5C) is adjusted so that terminal device 121 can receive a higher signal strength.

In practical applications, when the RSRP reported by a terminal device (e.g., terminal devices 111-114) reaches a threshold for the registration handover of a currently serving base station (e.g., base station Ci), the registration handover of the terminal device is not necessarily initiated immediately; the core network may evaluate the actual utilization rate of the field to determine whether to initiate the registration handover of the terminal device, thereby achieving energy saving.

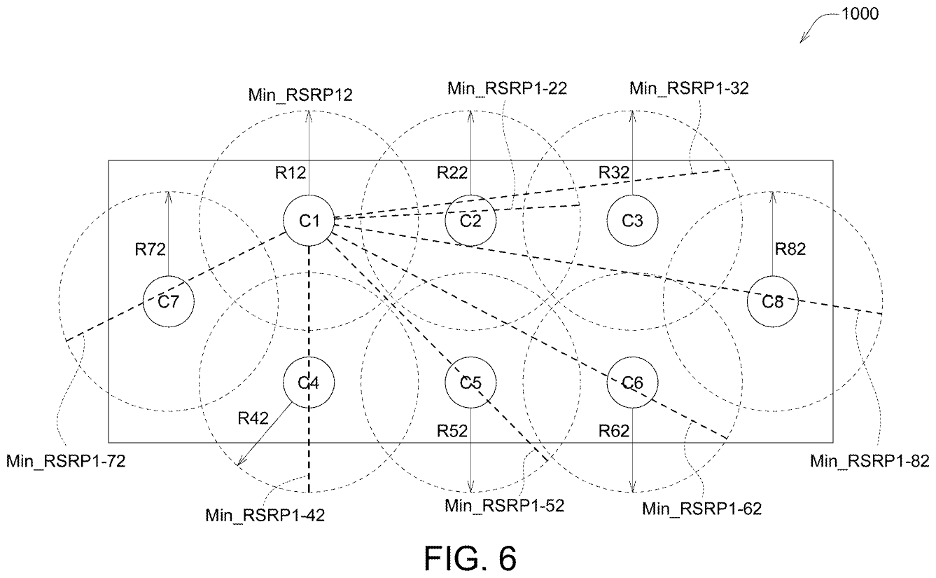

Next, after step S312, step S314 is executed: for a terminal device originally registered to base station Ci but currently operating at another base station Cj, the minimum signal strength Min_RSRPi-j2 at the registration handover distance Rj2 of base station Cj is measured. Please refer to FIG. 6, a schematic diagram showing the minimum signal strength Min_RSRPi-j2 of the terminal device at the registration handover distance Rj2 of the base station Cj. The terminal device was originally registered to base station Ci (i=1), but is currently operating at one of other base stations Cj (j=2−8). The signal strength of the terminal device at the registration handover distance Rj2 at base station Cj is measured, so as to obtain the minimum signal strength Min_RSRPi-j2. For example, the minimum signal strength Min_RSRP1-22 is obtained by measuring the signal at the registration handover distance R22 at base station C2, and the minimum signal strength Min_RSRP1-32 is obtained by measuring the signal at the registration handover distance R32 at base station C3; similarly, the minimum signal strength Min_RSRP1-82 is obtained by measuring the signal at the registration handover distance R82 at base station C8.

Then, in step S316, a weighted method is utilized to evaluate the reference values (referred to as “registration handover reference values”) for registration handovers at base stations C1-C8 in the field 1000. The terminal device was originally registered to base station Ci (i=1), and may perform registration handover to one of other base stations Cj (j=2-8) during operation. Base station Cj has a weight score W, which is set based on the signal strength RSRPi-j2 of base station Cj (relative to the originally registered base station Ci). As shown in Table 1, the weight score W is a function of the signal strength RSRPi-j2, and can be expressed as “W (RSRPi-j2)”. Specifically, if the signal strength RSRPi-j2 is greater than −80 dBm, the weight score W is 10; if the signal strength RSRPi-j2 is between −80 dBm and −85 dBm, the weight score W is 8; and so on, if the signal strength RSRPi-j2 is less than −130 dBm, the weight score W is 1. Therefore, the weight score W of base station Cj ranges from 1 to 10. In other examples, the signal-to-interference-plus-noise ratio (SINR) can also be considered when calculating the weight score W of base station Cj (j=2-8).

TABLE 1

| Signal strength RSRPi-j2 | Weight score W |
|---|---|
| (dBm) | (RSRPi-j2) |
| >=−80 | 10 |
| −80~−85 | 8 |
| −85~−90 | 7 |
| −90~−95 | 6 |
| −95~−100 | 5 |
| −100~−110 | 4 |
| −110~−120 | 3 |
| −120~−130 | 2 |
| <−130 | 1 |

The weight scores W of the seven base stations Cj (j=2-8) are summed to obtain a total weight score Wt. This total weight score Wt can be defined as the registration handover reference value for the registration handover from base station C1.

The weight scores W of the other base stations Cj (excluding base station C1) may range from 1 to 10, therefore the total weight score Wt ranges from 7 to 70; that is, the registration handover reference value for base station C1 ranges from 7 to 70. Using the same calculation method for the registration handover reference value of base station C1, the registration handover reference values for base stations C2-C8 can be calculated.

Then, in step S318, the order with which the base stations are activated is determined based on the registration handover reference value of base station Ci. Specifically, all base stations C1-C8 can typically be activated in field 1000, or a portion of base stations C1-C8 can be selectively activated depending on the number of registered terminal devices. In one example, the registration handover reference value of base station Ci is used as the reference for the activation order of the base stations.

Specifically, “field-supported-users'-number Nactive” means the number of users who can simultaneously register and actually connect to the network from all base stations C1-C8 in field 1000. Furthermore, “field-supported-registrations-number Nconn” means the number of users who can simultaneously register from all base stations C1-C8 in field 1000. The field-supported-users'-number Nactive is typically less than field-supported-registrations-number Nconn. On the other hand, “single-device-supported-users'-number Uactive” means the number of users who can simultaneously register and actually connect to the network from a single base station among base stations C1-C8. Furthermore, “single-device-supported-registrations-number Uconn” means the number of users who can simultaneously register from a single base station among base stations C1-C8. In one example, when the number of current number of registrations in field 1000 is less than single-device-supported-registrations-number Uconn, only one base station can be activated to provide service, so to achieve energy savings.

In another example, when the load on the currently activated base station is too heavy, a second base station can be activated to provide service. Specifically, a signal strength threshold Cr(RSRPi-j2) and a time threshold Cr(T) can be defined. If the current signal strength RSRPi-j2 of the terminal device is less than the signal strength threshold Cr(RSRPi-j2), and the duration T for the signal strength RSRPi-j2 being less than the signal strength threshold Cr(RSRPi-j2) is greater than the time threshold Cr(T), then a second base station is activated to provide service. For example, the base station with the lowest signal strength RSRPi-j2 can be prioritized for activation.

In another example, when the number of current number of registrations in field 1000 is less than half of field-supported-registrations-number Nconn, only half of the base stations C1-C8 can be activated to provide service, so as to achieve energy saving. For example, only base stations C1-C4 are activated.

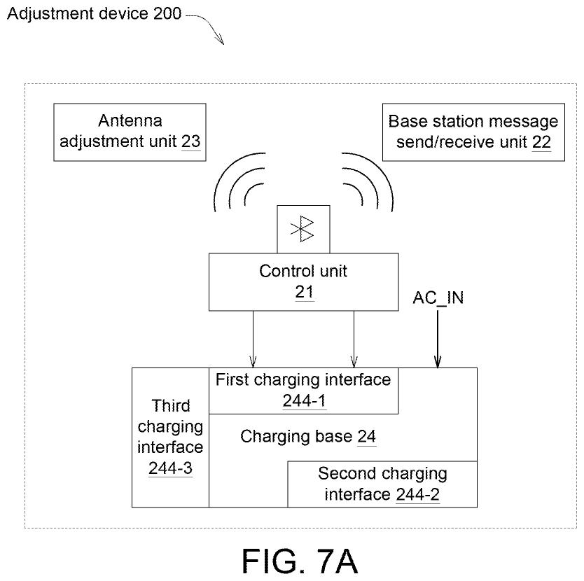

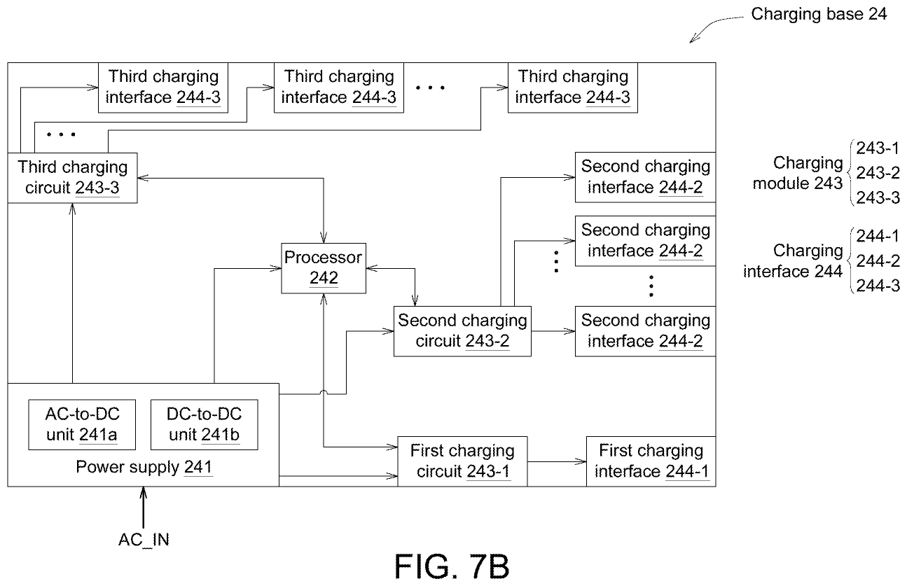

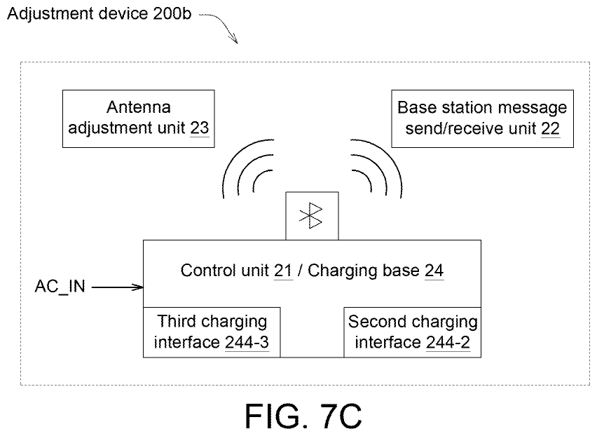

FIG. 7A is a block diagram of the adjustment device 200 according to an embodiment of the present disclosure. The adjustment device 200 can be used asaid when base stations C1-C8 are set up in the field 1000 of FIG. 1. For example, when deploying base stations C1-C8 in the field 1000, the antennas of base stations C1-C8 can be adjusted using the adjustment device 200, so as to optimize the RF signals provided by base stations C1-C8 to the field 1000. As shown in FIG. 7A, the adjustment device 200 includes a control unit 21, a base station message send/receive unit 22, an antenna adjustment unit 23 and a charging base 24.

The control unit 21 is used to adjust the angles of the antennas of base stations C1-C8. For example, the control unit 21 is a handheld control device operated by the user, allowing the user to dynamically adjust the angle of the antennas of base stations C1-C8 highly suspended in field 1000, via a ground-based operation of the control unit 21. Alternatively, the control unit 21 can automatically and dynamically adjust the angles of the antennas of base stations C1-C8 highly suspended in field 1000, via predefined control commands. The base station message send/receive unit 22 is used to transmit messages between base stations C1-C8 and the adjustment device 200. For example, the base station message send/receive unit 22 transmits and receives messages with base stations C1-C8 via a base station serial port. The antenna adjustment unit 23 is used to adjust the angles of the antennas of base stations C1-C8.

The control unit 21, the base station message send/receive unit 22 and the antenna adjustment unit 23 can communicate with one another via Bluetooth or Wi-Fi. In an example of the Bluetooth, the control unit 21 has a master role, and base station message send/receive unit 22 and antenna adjustment unit 23 have slave roles. The base station message send/receive unit 22 and antenna adjustment unit 23 have connection interfaces with hardware mechanism (not shown), so as to facilitate the embedding into the body of base stations C1-C8. The antenna adjustment unit 23 is detachably coupled between the body of base stations C1-C8 and the antennas installed on base stations C1-C8.

The charging base 24 includes a first charging interface 244-1, a second charging interface 244-2 and a third charging interface 244-3. The control unit 21 can be coupled to charging base 24 via the first charging interface 244-1, so as to receive the power provided by the charging base 24. Similarly, the base station message send/receive unit 22 and the antenna adjustment unit 23 can be coupled to the charging base 24 via the second charging interface 244-2 and the third charging interface 244-3 respectively, so as to receive the power from the charging base 24.

The charging base 24 can provide the power from an external AC input power source AC_IN or an internal battery (not shown) to the control unit 21, the base station message send/receive unit 22 and the antenna adjustment unit 23, via the first charging interface 244-1, the second charging interface 244-2 and the third charging interface 244-3 respectively.

FIG. 7B is a block diagram of the charging base 24. The charging base 24 includes a power supply 241, a processor 242, a charging module 243 and a charging interface 244. The power supply 241 includes an AC-to-DC unit 241a and a DC-to-DC unit 241b. The AC-to-DC unit 241a converts the AC input power AC_IN to an initial DC power, and the DC-to-DC unit 241b converts the initial DC power generated by the AC-to-DC unit 241a into a DC power which is usable by the components of charging base 24. The charging module 243 includes a first charging circuit 243-1, a second charging circuit 243-2 and a third charging circuit 243-3. The DC power generated by the DC-to-DC unit 241b is provided to the first charging circuit 243-1, the second charging circuit 243-2 and the third charging circuit 243-3. The processor 242 can monitor the status of the first charging circuit 243-1, the second charging circuit 243-2 and the third charging circuit 243-3.

The charging interface 244 includes a first charging interface 244-1, a second charging interface 244-2 and a third charging interface 244-3. The charging interface 244 is, for example, a USB interface which can support USB-PD fast charging and wireless charging. The first charging circuit 243-1 is connected to the first charging interface 244-1 and is used for charging the control unit 21. Similarly, the second charging circuit 243-2 is connected to the second charging interface 244-2 and is used for charging the base station message send/receive unit 22. The third charging circuit 243-3 is connected to the third charging interface 244-3 and is used for charging the antenna adjustment unit 23.

FIG. 7C is a block diagram of the adjustment device 200b according to another embodiment of the present disclosure. The adjustment device 200b of this embodiment is a variation of the adjustment device 200 of FIG. 7A. The charging base 24 of the adjustment device 200b can be selectively integrated into the control unit 21, so as to charge the base station message send/receive unit 22 and the antenna adjustment unit 23.

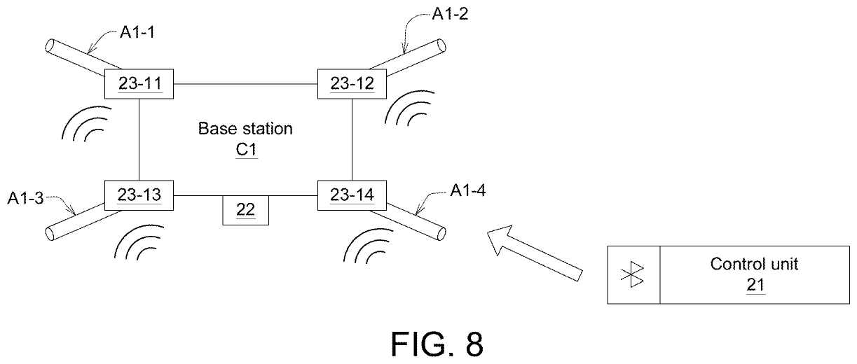

FIG. 8 is a schematic diagram showing the adjustment for multiple antennas of the base station C1. The base station C1 includes, for example, four antennas A1-1, A1-2, A1-3 and A1-4. The user firstly embeds the base station message send/receive unit 22 and antenna adjustment units 23-11, 23-12, 23-13 and 23-14 of the adjustment device 200 into base station C1. The antenna adjustment units 23-11 to 23-14 are detachably coupled between the body of the base station C1 and antennas A1-1 to A1-4.

The user may then mount the base station C1 to a predefined deployment location in the field 1000. Then, the user operates the control unit 21 to control the antenna adjustment units 23-11 to 23-14, so as to adjust and test the angles of antennas A1-1 to A1-4 of base station C1 (or the control unit 21 can automatically adjust the angles of antennas A1-1 to A1-4 of base station C1 through predefined control commands). The user confirms that the test results satisfy the application requirements of field 1000. If the requirements of field 1000 are satisfied, the user removes base station C1 from its mounting position in field 1000. Based on the test results, the user adjusts antennas A1-1 to A1-4 of base station C1 to predefined angles, using antenna adjustment units 23-11 to 23-14. Then, the user removes base station message send/receive unit 22 and antenna adjustment units 23-11 to 23-14 from base station C1. Finally, base station C1 is re-mounted to its predefined deployment position in field 1000, thus completing the deployment procedure of base station C1 in field 1000. In one embodiment, the base station message send/receive unit 22 and antenna adjustment units 23-11 to 23-14 may not be removed from base station C1.

The user can set multiple hotspot locations in the field 1000. Furthermore, at these hotspot locations, the user can employ a terminal device or signal scanner to measure signal parameters (e.g., signal strength RSRP, SINR) of the base station C1, so as to evaluate the signal quality at these hotspot locations. When evaluating the signal quality at these hotspot locations using the terminal device or signal scanner, compensations and adjustments can be made for additional insertion loss introduced to the base station C1 by the adjustment device 200.

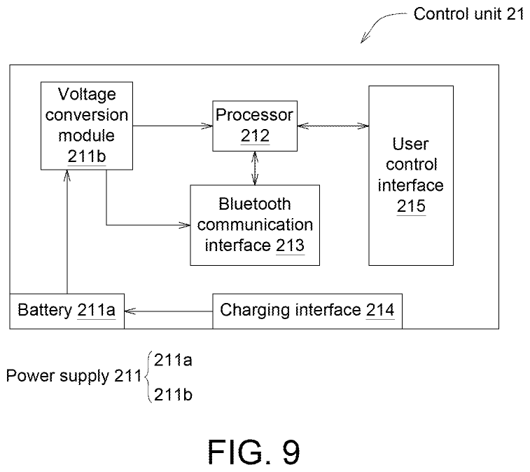

FIG. 9 is a block diagram of the control unit 21. The control unit 21 includes a power supply 211, a processor 212, a Bluetooth communication interface 213, a charging interface 214, and a user control interface 215.

The power supply 211 includes a battery 211a and a voltage conversion module 211b. The battery 211a is, for example, a built-in rechargeable battery, and the voltage conversion module 211b performs DC-DC voltage conversion. The power supply 211 provides necessary power to the various components of the control unit 21.

The charging interface 214 has a connection structure to facilitate connecting to the charging base 24. The charging base 24 provides charging power to the power supply 211 via the charging interface 214.

The Bluetooth communication interface 213 is used to perform communication among the control unit 21, the base station message send/receive unit 22, and the antenna adjustment unit 23. The control unit 21 transmits data with the base station message send/receive unit 22 via the serial port profile (SPP) of the Bluetooth protocol, and sends commands to the antenna adjustment unit 23 via the Bluetooth communication interface 213, so as to control the antenna adjustment unit 23 to adjust the antenna of the base station.

The user control interface 215 is, for example, a touch panel, an external keyboard and mouse, or a virtual keyboard, etc. The user can input data and/or commands to the control unit 21 via the user control interface 215, and the control unit 21 converts the data and/or commands inputted by the user into text files, and transmits the data and/or commands to the antenna adjustment unit 23.

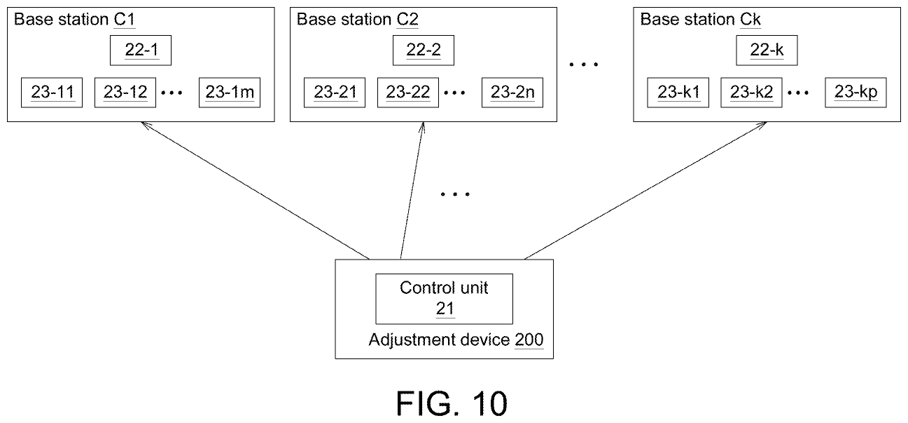

FIG. 10 is a schematic diagram showing the control unit 21 performs Bluetooth pairing. The control unit 21 performs controlling in a one-to-many manner, allowing the user to adjust multiple base stations C1, C2, . . . , Ck in the field 1000, via the control unit 21 of the same adjustment device 200. Each of base stations C1-Ck must be equipped with one base station message send/receive unit and at least one antenna adjustment unit (the number of antenna adjustment units is equal to the number of antennas (e.g., MIMO antennas) of this base station). In the embodiment of FIG. 10, each of base stations C1-Ck may be equipped with a different number of antenna adjustment units. For example, base station C1 is equipped with one base station message send/receive unit 22-1 and antenna adjustment units 23-11, 23-12, . . . , 23-1m with a number of “m”. Base station C2 is equipped with one base station message send/receive unit 22-2 and n antenna adjustment units 23-21, 23-22, . . . , 23-2n with a number of “n”. Base station Ck is equipped with one base station message send/receive unit 22-k and antenna adjustment units 23-k1, 23-k2, . . . , 23-kp with a number of “p”. The numbers “m”, “n” and “p” are unequal positive integers. In other examples, each of base stations C1-Ck may be equipped with the same number of antenna adjustment units.

Before adjusting the antennas of base stations C1-Ck, the control unit 21 currently operated by the user may perform Bluetooth pairing (i.e., master-slave pairing of the Bluetooth protocol) with the base station message send/receive units 22-1 to 22-k and antenna adjustment units 23-11 to 23-1m, 23-21 to 23-2n, . . . , 23-k1 to 23-kp of base stations C1-Ck. The control unit 21 plays the master role in the Bluetooth protocol, possessing an active authority to initiate Bluetooth communication. The base station message send/receive units 22-1 to 22-k and antenna adjustment units 23-11 to 23-1m, 23-21 to 23-2n, . . . , 23-k1 to 23-kp play the slave roles in the Bluetooth protocol.

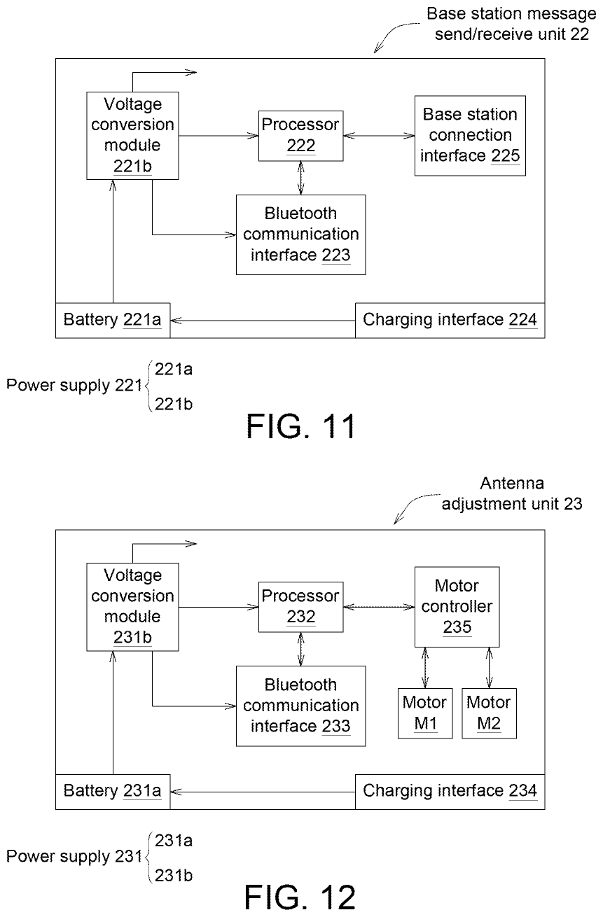

FIG. 11 is a block diagram of the base station message send/receive unit 22. The base station message send/receive unit 22 includes a power supply 221, a processor 222, a Bluetooth communication interface 223, a charging interface 224 and a base station connection interface 225. The base station message send/receive unit 22 allows users to remotely monitor the status of base stations C1-C8 from the ground. When base stations C1-C8 are deployed in the field 1000 and their functions are tested, the user obtains the real-time status of base stations C1-C8 through the base station message send/receive unit 22. The power supply 221 includes a battery 221a (e.g., a built-in rechargeable battery) and a voltage conversion module 221b to perform voltage conversion, providing necessary power to the various components of the base station message send/receive unit 22.

The base station connection interface 225 can be adapted to the serial-port/console-port of base stations C1-C8, such as an RJ45 serial port. Furthermore, it can be adapted to other types of connection ports of base stations C1-C8 via adapters such as RJ45-to-USB and RJ45-to-RS232.

The base station message send/receive unit 22 communicates with the control unit 21 and the antenna adjustment unit 23 via the Serial Port Profile (SPP) of Bluetooth. The Bluetooth communication interface 223 of the base station message send/receive unit 22 receives messages from the control unit 21, and the processor 222 of the base station message send/receive unit 22 converts these messages into a message format that can be processed by the serial ports of base stations C1-C8. Then, the converted message is transmitted to base stations C1-C8 via the Bluetooth communication interface 223. Users can test and verify the system parameters of base stations C1-C8 via the base station message send/receive unit 22. System parameters include throughput or other indicators for quality evaluation.

FIG. 12 is a block diagram of the antenna adjustment unit 23. The antenna adjustment unit 23 includes a power supply 231, a processor 232, a Bluetooth communication interface 233, a charging interface 234, a motor controller 235, and motors M1 and M2. The power supply 231 includes a battery 231a and a voltage conversion module 231b for voltage converting, so as to provide power to the components of the antenna adjustment unit 23. The Bluetooth communication interface 233 is used to establish communication with the control unit 21.

The Bluetooth communication interface 233 receives commands from the control unit 21. The processor 232 is used to process the commands received by the Bluetooth communication interface 233, and control the motor controller 235 to drive the rotation of motors M1 and M2 based on the commands, so as to adjust the antennas of base stations C1-C8.

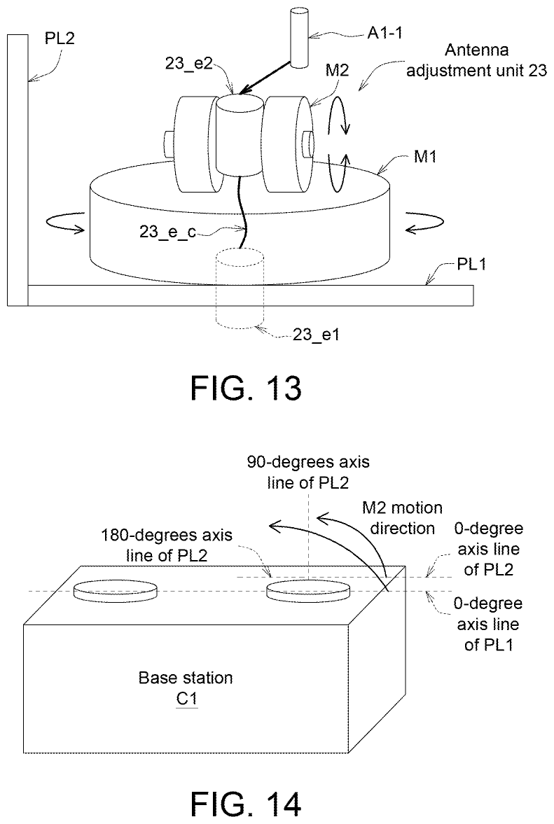

FIG. 13 is a schematic diagram showing the operation of the antenna adjustment unit 23. The base station C1 and one antenna A1-1 are taken as an example for the following descriptions. Firstly, antenna A1-1 is temporarily removed from base station C1. Then, the first end 23_e1 of the antenna adjustment unit 23 is connected to the antenna connection interface C1_e1 of the base station C1, and the antenna A1-1 is connected to the second end 23_e2 of the antenna adjustment unit 23. That is, the antenna adjustment unit 23 has a first end 23_e1 that can be directly connected to the antenna connection interface C1_e1 of the housing of the base station C1, which is originally connected to the antenna A1-1. Furthermore, the antenna adjustment unit 23 has a second end 23_e2 that can be directly connected to the antenna A1-1. The first end 23_e1 is connected to the second end 23_e2 via an RF cable 23_e_c. In one example, the first end 23_e1 and the second end 23_e2 can be selectively connected to the antenna A1-1 and the antenna connection interface C1_e1 of the base station C1 via an adapter (e.g., N-connector-to-SMA, or female-to-male).

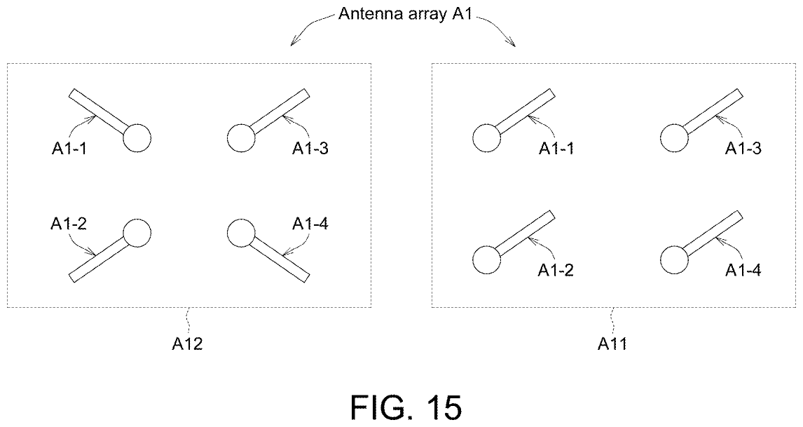

FIG. 14 is a schematic diagram showing the axes of the XY plane PL1 and the Z plane PL2 of the base station C1, and the rotation directions of the motors M1 and M2 of the antenna adjustment unit 23. The user operates the control unit 21 to generate control signals (or the control unit 21 automatically generates control signals through predefined control commands). The control signals are transmitted to motor controller 235 of antenna adjustment unit 23 via Bluetooth communication interface 233, so as to drive motors M1 and M2 to rotate in the XY plane PL1 (which is referred to as the first plane) and the Z plane PL2 (which is referred to as the second plane) respectively. The XY plane PL1 is, for example, a reference plane of base station C1, and the Z plane PL2 is substantially perpendicular to the XY plane PL1. The Motor M1 controls the rotation angle (i.e., the first angle θ) of antenna A1-1 in the XY plane PL1, and the motor M2 controls the rotation angle (i.e., the second angle q) of antenna A1-1 in the Z plane PL2. The XY axis direction is defined as the initial zero-degree direction of the XY plane PL1. The point where the XY plane PL1 and the Z plane PL2 coincide is defined as the initial zero-degree direction of the Z plane PL2. When initial zero-point calibration is performed on motors M1 and M2, the zero-degree position of motor M1 is the initial zero-degree direction of the XY plane PL1, and the zero-degree position of motor M2 is the initial zero-degree direction of the Z plane PL2.

The rotation range of motor M1 is, for example, within 180 degrees of the XY plane PL1, and the rotation range of motor M2 is, for example, within 180 degrees of the Z plane PL2. The 180-degree ranges of both the XY plane PL1 and the Z plane PL2 are divided into 6 graduations, with each graduation being 30 degrees. The rotation amplitude of motors M1 and M2 for each time is, for example, a multiple of 30 degrees. Alternatively, the 180-degree ranges of both the XY plane PL1 and Z plane PL2 are divided into 12 graduations, with each graduation being 15 degrees. The rotation amplitude for each time is a multiple of 15 degrees, and so on.

FIG. 15 is a schematic diagram showing the adjusting for the antenna array A1 of the base station C1. The antenna array A1 is, for example, a MIMO antenna. The antenna array A1 includes antennas A1-1, A1-2, A1-3 and A1-4. The antennas A1-1 to A1-4 are arranged in a unidirectional type A11 or a symmetrical type A12.

Antennas A1-1 to A1-4 are coupled to base station C1 via antenna adjustment units 23-11 to 23-14 of adjustment device 200, respectively. The user operates the control unit 21 of adjustment device 200 to control the antenna adjustment units 23-11 to 23-14 to adjust antennas A1-1 to A1-4. Control unit 21 can control antennas A1-1 to A1-4 to be adjusted one by one, or to be adjusted in batches according to a single instruction from a predefined application script.

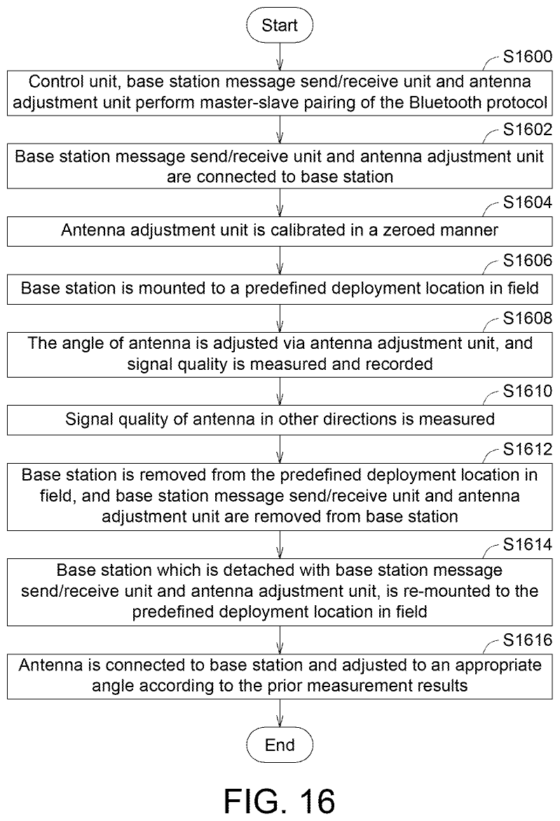

FIG. 16 is a flow diagram of an optimization method for a field RF signal according to another embodiment of the present disclosure. Referring to FIG. 16 in conjunction with FIG. 7A to FIG. 15, the method is described taking the antenna A1-1 of base station C1 as an example. In step S1600, control unit 21 performs master-slave pairing of the Bluetooth protocol with base station message send/receive unit 22-1 and antenna adjustment unit 23-11. Then, in step S1602, base station message send/receive unit 22-1 is connected to base station C1, and likewise, antenna adjustment unit 23-11 is connected to base station C1.

Then, in step S1604, zero-point calibration is performed on antenna adjustment unit 23-11. Then, in step S1606, the base station C1 is mounted to a predefined deployment location in field 1000.

Then, in step S1608, the angle of antenna A1-1 is adjusted via antenna adjustment unit 23-11, and signal quality is measured and recorded. Then, in step S1610, the signal quality of antenna A1-1 in other directions is measured.

Then, in step S1612, the base station C1 is removed from the predefined deployment location in field 1000, and base station message send/receive unit 22-1 and antenna adjustment unit 23-11 are removed from base station C1.

Then, in step S1614, the base station C1 from which base station message send/receive unit 22-1 and antenna adjustment unit 23-11 have been removed is re-mounted to the predefined deployment location in field 1000. Then, in step S1616, antenna A1-1 is connected to base station C1, and antenna A1-1 is adjusted to an appropriate angle according to the measurement results of steps S1608 and S1610.

In summary, the adjustment device 200 and the method for optimizing field RF signals of the present disclosure can be applied to base stations equipped with built-in antennas or using external antennas. The adjustment device 200 and the optimization method can complete the signal quality planning in a preparatory stage of the field deployment, and confirm the signal quality in a stage of actual deployment. Therefore, they can satisfy the application requirements of the field, the demands for registration handover of terminal devices, and the purpose of energy saving.

It will be apparent to those skilled in the art that various modifications and variations can be made to the disclosed embodiments. It is intended that the specification and examples be considered as exemplars only, with a true scope of the disclosure being indicated by the following claims and their equivalents.

What is claimed is:

1. An adjustment device, for adjusting at least one antenna of a base station, wherein the base station is deployed at a predefined deployment location in a field, the adjustment device comprising:
an antenna adjustment unit, for adjusting a plurality of angles of the at least one antenna; and
a control unit, for adjusting the angles of the at least one antenna via the antenna adjustment unit, such that a radio frequency (RF) signal of the base station received by a terminal device at a coverage distance and a registration handover distance of the base station respectively reaches a first minimum signal strength and a second minimum signal strength,
wherein, when the terminal device reaches a lower limit of a predefined uplink rate and a lower limit of a predefined downlink rate at the coverage distance, the terminal device selectively initiates registration handover of the base station at the registration handover distance, wherein a deployment reference distance between the base station and an adjacent base station is greater than or equal to the coverage distance, and the coverage distance is greater than or equal to the registration handover distance.

2. The adjustment device of claim 1, wherein the first minimum signal strength and the second minimum signal strength are associated with a reference signal received power (RSRP) and signal-to-interference-plus-noise ratio (SINR) of the RF signal of the base station received by the terminal device.

3. The adjustment device of claim 1, wherein the angles of the at least one antenna comprise a first angle of a first plane and a second angle of a second plane, the first plane is a reference plane of the base station, and the second plane is substantially perpendicular to the first plane.

4. The adjustment device of claim 3, wherein the antenna adjustment unit has a slave role of a Bluetooth protocol and is detachably coupled between the base station and the at least one antenna, and the antenna adjustment unit comprises:
a first motor, for adjusting the first angle of the at least one antenna; and
a second motor, for adjusting the second angle of the at least one antenna.

5. The adjustment device of claim 1 further comprises:
a base station message send/receive unit, detachably coupled to the base station, and for converting messages of the control unit to adapt to a serial port of the base station,
wherein the base station message send/receive unit has the slave role of the Bluetooth protocol, and the control unit has a master role of the Bluetooth protocol.

6. The adjustment device of claim 5 further comprises:
a charging base, comprises:
a plurality of charging interfaces, correspondingly coupled to the control unit, the base station message send/receive unit and the antenna adjustment unit; and
a plurality of charging circuits, for providing power to the control unit, the base station message send/receive unit and the antenna adjustment unit via the charging interfaces,
wherein the charging base is selectively integrated into the control unit.

7. The adjustment device of claim 5, wherein a first base station is further deployed in the field, the first base station has at least one first antenna, and the adjustment device further comprises:
a first base station message send/receive unit, detachably coupled to the first base station, and used for converting messages of the control unit; and
a first antenna adjustment unit, detachably coupled between the first base station and the at least one first antenna, and used for adjusting the at least one first antenna,
wherein the first base station message send/receive unit and the first antenna adjustment unit have the slave role of the Bluetooth protocol, and the control unit performs master-slave pairing of the Bluetooth protocol with the base station message send/receive unit, the first base station message send/receive unit, the antenna adjustment unit and the first antenna adjustment unit.

8. The adjustment device of claim 1, wherein a first base station is further deployed in the field, the second minimum signal strength of the terminal device at the registration handover distance of the first base station corresponds to a weight score, and a registration handover reference value for the terminal device to initiate registration handover of the base station is associated with the weight score.

9. The adjustment device of claim 8, wherein when the second minimum signal strength of the terminal device in the first base station is less than a signal strength threshold for a duration greater than a time threshold, a second base station in the field is activated to serve the terminal device.

10. The adjustment device of claim 1, wherein the base station has an antenna array, and the control unit controls the antenna array to be adjusted individually or in batches.

11. A field radio frequency (RF) signal optimization method, for adjusting at least one antenna of a base station deployed in a field, comprising:
mounting the base station at a predefined deployment location in the field;
controlling an antenna adjustment unit by a control unit;
adjusting a plurality of angles of the at least one antenna by the antenna adjustment unit;
causing a terminal device to receive an RF signal of the base station at a coverage distance of the base station to reach a first minimum signal strength, wherein the terminal device reaches a lower limit of a predefined uplink rate and a lower limit of a predefined downlink rate at the coverage distance; and
causing the terminal device to receive the RF signal of the base station at a registration handover distance of the base station to reach a second minimum signal strength, wherein the terminal device selectively initiates registration handover of the base station at the registration handover distance,
wherein a deployment reference distance between the base station and an adjacent base station is greater than or equal to the coverage distance, and the coverage distance is greater than or equal to the registration handover distance.

12. The field RF signal optimization method of claim 11, wherein the first minimum signal strength and the second minimum signal strength are associated with a reference signal received power (RSRP) and signal-to-interference-plus-noise ratio (SINR) of the RF signal of the base station received by the terminal device.

13. The field RF signal optimization method of claim 11, wherein the angles of the at least one antenna comprise a first angle of a first plane and a second angle of a second plane, the first plane is a reference plane of the base station, and the second plane is substantially perpendicular to the first plane.

14. The field RF signal optimization method of claim 13, wherein the antenna adjustment unit has a slave role of a Bluetooth protocol, and the step of adjusting the angles of the at least one antenna by the antenna adjustment unit comprises:
coupling the antenna adjustment unit between the base station and the at least one antenna;
adjusting the first angle of the at least one antenna by a first motor of the antenna adjustment unit; and
adjusting the second angle of the at least one antenna by a second motor of the antenna adjustment unit.

15. The field RF signal optimization method of claim 11, wherein the control unit has a master role of a Bluetooth protocol, and before the step of controlling the antenna adjustment unit by the control unit via a Bluetooth communication interface, the optimization method further comprises:
coupling a base station message send/receive unit to the base station, wherein the base station message send/receive unit has the slave role of the Bluetooth protocol; and
converting messages of the control unit by the base station message send/receive unit to adapt to a serial port of the base station.

16. The field RF signal optimization method of claim 15, further comprises:
coupling a plurality of charging interfaces of a charging base to the control unit, the base station message send/receive unit and the antenna adjustment unit correspondingly; and
providing power to the control unit, the base station message send/receive unit and the antenna adjustment unit via the charging interfaces by a plurality of charging circuits of the charging base,
wherein the charging base is selectively integrated into the control unit.

17. The field RF signal optimization method of claim 15, wherein is further deployed in the field a first base station, the first base station has at least one first antenna, and the optimization method further comprises:
performing master-slave pairing of the Bluetooth protocol with the base station message send/receive unit, a first base station message send/receive unit, the antenna adjustment unit and a first antenna adjustment unit by the control unit, wherein the first base station message send/receive unit and the first antenna adjustment unit have the slave role of the Bluetooth protocol;
coupling the first base station message send/receive unit to the first base station;
coupling the first antenna adjustment unit between the first base station and the at least one first antenna;
converting messages of the control unit by the first base station message send/receive unit; and
adjusting the at least one first antenna by the first antenna adjustment unit.

18. The field RF signal optimization method of claim 11, is further deployed in the field a first base station, and the optimization method further comprises:
obtaining a weight score based on the second minimum signal strength of the terminal device at the registration handover distance of the first base station; and
calculating a registration handover reference value for the terminal device to initiate registration handover of the base station based on the weight score.

19. The field RF signal optimization method of claim 18, further comprises:
analyzing a duration for which the second minimum signal strength of the terminal device in the first base station is less than a signal strength threshold; and
when the duration for which the second minimum signal strength being less than the signal strength threshold is greater than a time threshold, activating a second base station in the field to serve the terminal device.

20. The field RF signal optimization method of claim 11, wherein the base station has an antenna array, and the optimization method further comprises:
controlling the antenna array to be adjusted individually or in batches, by the control unit.
